(19) United States
(12) Patent Application Publication
(10) Pub. No.: US 2015/0256323 A1
(43) Pub. Date: Sep. 10, 2015

(54) METHOD AND SYSTEM FOR CREATING TWO INDEPENDENT WIRELESS NETWORKS WITH AN ACCESS POINT

(71) Applicant: TELEFONICA, S.A., Madrid (ES)

(72) Inventors: Carlos Gandarillas Diego, Madrid (ES); Hector Lopez Pombo, Madrid (ES); Wsewolod Warzanskyj Garcia, Madrid (ES)

(73) Assignee: TELEFONICA, S.A., Madrid (ES)

(21) Appl. No.: 14/431,664

(22) PCT Filed: Sep. 18, 2013
(86) PCT No.: PCT/EP2013/069334

§ 371 Date: Mar. 26, 2015

(30) Foreign Application Priority Data
Sep. 27, 2012 (ES) P201231496

(51) Int. Cl. H04L 5/16; H04W 72/04

(52) U.S. Cl. CPC H04L 5/16; H04W 72/0453; H04W 84/12

(57) ABSTRACT

The method comprising at least one Access Point (AP) with a single half duplex radio transceiver allowing the transmission from said AP to a plurality of associated stations connected to any of said two wireless networks, said two wireless networks operating at different frequency channels. Embodiments of the method in order to create said two wireless networks comprises said at least one AP updating a plurality of beacon parameters from a beacon frame at each change of channel frequency of said half duplex radio transceiver.

The system of the invention is adapted to implement the method of the invention.

### FIELD OF THE ART

The present invention generally relates, in a first aspect, to a method for creating two independent wireless networks with an access point, and more particularly to a method for allowing an Access Point to support two WLAN networks in a dual frequency channel scheme.

A second aspect of the invention relates to a system adapted to implement the method of the first aspect.

The term beacon frame is to be understood one of the management frames in IEEE 802.11 based WLANs. It contains all the information about the network. Beacon frames are transmitted periodically to announce the presence of a Wireless LAN network. Beacon frames are transmitted by the Access Point (AP) in an infrastructure BSS.

### PRIOR STATE OF THE ART

Nowadays, the proliferation of wireless communications in home environments produces dense networks of access points that share the same radio environment, creating a phenomenon known as co-channel interference. Transmission of real time services, like video-streaming or any high data rate services, can be hampered by the interference created by nearby wireless LAN transmitting devices.

In this type of situation it becomes advisable to work in the best operating frequency channel, the less interfered one. In the case when the channel is dynamically interfered a method should be found for changing to the best frequency channel in a smart way. Working in the less interfered channel entails an improvement in WLAN link performance, achieving better received SNR and communication throughput.

A possible solution for increasing throughput and avoiding interference is to have a dual transceiver in WLAN devices, which allows supporting WLAN communications in other frequency bands or channels, if the first one is interfered.

The state of the art for dual WLANs transmission, other related mechanisms for dual frequency channel and frequency channel change, as well as a dual transmission related method description in 802.11 WLANs, are explained below.

In addition to this, it can be useful to prioritize the wireless transmissions that the user considers of high priority. This can be achieved by assigning them a non-interfered, or lightly interfered, channel, leaving the other interfered channels for low priority WLAN transmissions.

Regarding the dual communication method proposed in the invention, there are methods for transmitting dual or multiple SSID WLAN from one Access Point, but they achieve it by using the same frequency channel or by implementing dual RF transceivers.

In case of interference in WLAN communications there are some advanced mechanisms for changing the frequency channel which are described in this section.

Frequency channel change and smart frequency channel assessments are critically important in wireless communication systems. Many wireless technologies that share unlicensed spectrum (2.4 GHz and 5 GHz Frequency Bands) implement methods for co-existence and dynamically changing their frequency channel in case of being interfered. These methods for managing the working frequency channel, usually called Frequency Agile methods or Smart Frequency Channel methods, attempt to minimize the interference between co-located neighbour wireless systems.

Dual-Multiple SSID:

In IEEE 802.11 [1] the variable length SSID field contains the identity of the extended service set (ESS). The maximum length is 32 bytes, and when the SSID has a length of zero, it is considered to be the broadcast SSID. A Probe Request frame having a broadcast SSID causes all access points to respond with a Probe Response frame. Its purpose is to stop other wireless equipment accessing the LAN—whether accidentally or intentionally. To communicate with the access point (AP), WLAN devices must be configured with the same SSID. If the ‘Allow broadcast of SSID’ command is unselected in a router or access point, the SSID of that device will not be visible in the other device's site survey, and, if a device wants to become associated with the router or access point the SSID must be entered manually.

The Extended Service Set Identification (ESSID) is one of two types of Service Set Identification (SSID) parameters. An ad-hoc wireless network with no access points uses the Basic Service Set Identification (BSSID). In an infrastructure wireless network that includes an access point, the Extended Service Set Identification (ESSID) is used—although it may still be referred in a loose sense as SSID. Some vendors refer to the SSID as the “network name”. IEEE 802.11 standard WLANs periodically broadcast or announce the identifier of the network. This is done by means of the beacon frame, typically each 100 ms. The beacon frame broadcasts the following information (about 40 bytes):
MAC address of the router.
Name of the network (32 bytes maximum for SSID).
Time.
Periodicity of the beacon.
Information bits that define the network type (ad-hoc, infrastructure . . . )
Other parameters.

Nowadays, most WLAN devices support dual SSID transmissions, i.e., dual SSID allows the transmission of simultaneous WLANs in the same Access Point. In the case of dual SSID, two beacon frames should be sent every 100 ms. Dual SSID broadcasting allows creating two networks with one same router, which are termed virtual local area networks (VLAN). Usually one is reserved for public, and the other for private, use.

Dual or Multiple SSID transmissions share the same frequency channel and medium capacity. There are also devices that include a WLAN switch. The WLAN switch provides an independent connectivity to each of the VLAN, with different security requirements. FIG. 1 shows the WLAN switch scheme.

Device Manufacturer Solutions—Dual Band WLAN/DFS:

The most important approaches to the described invention, developed by manufacturers, are based on the design of WLAN routers with dual frequency band transceivers, which allow dual channel WLAN transmission, each one with one or more different SSID.

Looking for the highest throughputs and communication features, many WLAN manufacturers have made devices with dual frequency transceivers, one in the 2.4 GHz and the other in 5 GHz band. A case can be implemented in which the dual frequency transceivers are in the same frequency band, the 5 GHz band, allowing dual transmissions in the 5 GHz band. The cost of these devices is higher than the cost of the ones with a single radio transceiver.

In Wi-Fi wireless networking, dual band is the capability to support the 802.11a and 802.11n standards in the 5 GHz band and standards 802.11b, 802.11g, and 802.11n in the 2.4 GHz legacy band. Unlike ordinary Wi-Fi equipment that only supports one signal band, dual-band gear contains two different types of wireless radios that can support connections with both 2.4 GHz and 5 GHz links. Usually the two WLAN bands are used as independent transmission communication channels, not allowing the transfer of information and communications data from one to another. A brief and quick selection of some manufacturer solutions with dual, 5 and 2.4 GHz, frequency band WLAN transceivers are Cisco-Linksys WRT610nv2 and E4200v2, Netgear WNHD37000, Asus RT-N56u and D-link amplify HD media router 2000 DIR-827.

In addition to this, most WLAN manufacturers do not implement the dynamic smart frequency channel selection (DFS channel change in 5 GHz) in case of interference in the operating channel in the 5 GHz band. Some of them implement algorithms and methods for changing the frequency channel without interrupting the wireless communication based on going to non-DFS 5 GHz channels (Airties manufacturer solution). This solution saturates the existing two non-DFS 40 MHz BW channels. Some of the manufacturers which allow dynamic frequency channel change are shown below.
Airties: Based on Quantenna WLAN chipset, they have defined a Wi-Fi dynamic channel change in case of interferences. In order to avoid the minimum waiting time defined in the DFS (1 minute minimum), the channel change always goes to the first non-DFS channel, in which there is no need of waiting and scanning for radars (as is mandatory en DFS).
Ruckus: in some of its WLAN devices a performance list includes a ‘smart frequency channel change’ capability. Only available between APs and STAs of the Ruckus brand. No more information about the method is provided. It is supposed that it complies with the DFS specification.

IEEE 802.11 Standard: IEEE does not define the use or the implementation of multiple transmissions within the same Access Point. IEEE 802.11-2012 defines the multiple SSID capability and procedures for transmitting from a single beacon. No references have been found regarding multiple transmissions on different frequencies and times.

The previous statement non withstanding, IEEE does define a dual beacon transmission. The dual beacon is used to enable high throughput (HT) transmission, and, in particular, Space Time Block Coding (STBC). Single beacon frames are sent using the lowest basic data rate, because of backward compatibly requirements, and thus have not size enough to define an STBC, i.e, an increase in Basic Service Set (BSS) size. Enlarged BSS definition is then supported by a second beacon: the first beacon is called primary beacon and is a legacy one that enables backward compatibility; the second supports the STBC definition. The ‘dual beacon’ defined in the IEEE has nothing to do with the beacon frames for allowing a dual WLAN communication described in this invention. Dual beacon feature is not used for implementing the invention.

Regarding enhanced operation in the 5 GHz band, IEEE 802.11h [2] defines two mechanisms on top of 802.11 PHY and MAC layers, namely Transmit Power Control (TPC) and Dynamic Frequency Selection (DFS), that are related to the dynamically frequency channel change addressed in this invention.

Regarding frequency change, IEEE 802.11 specifications (section 10.9 in IEEE 802.11-2012) define DFS with a set of rules for meeting ETSI regulations. DFS (ERC/DEC/(99) 23) and ETSI [3] require Radio LANs operating in the 5 GHz band to implement mechanisms to avoid co-channel operation with radar systems and to ensure a uniform utilization of available channels. According to these rules, the AP takes the decision of switching to a new operating channel. The method to choose the new channel and to detect radars before channel switching is not defined in the specification. The DFS defined rules and functions leave an open way for free implementations of smart frequency channel change mechanisms in WLAN devices. IEEE 802.11 also defines a channel switch announcement frame in order to make it possible to advertise a channel switch to the associated station.

Methods and Algorithms for Dual WLAN Transmission and Frequency Channel Change:

There are some methods and algorithms for dual WLAN transmission and frequency channel change. For instance, [4] deals with channel switching with a single radio transceiver and defines the concept of on-demand channel switching (ODC). ODC is a broadcast-based medium access control (MAC) protocol for ad-hoc wireless networks with multiple channels and a single half-duplex transceiver at each host. ODC specifies an on-demand; dynamic channel selection mechanism based on the traffic conditions of the channels and communication patterns of the participating hosts. A host stays on a channel as long as its traffic share on that channel is above a certain threshold, below which it switches to another channel. It broadcasts its departure and arrival before and after each channel switch, respectively.

Another example is [5] which propose a method for frequency hopping in 802.11 WLANs in order to avoid jammer attacks. Jammers can interfere the channel preventing and deferring WLAN transmissions. The reference proposes frequency hopping to solve this drawback.

Other procedures regarding methods for WLANs frequency channel change are described in references [6] and [7].

There are also some related patents in order to achieve dual WLAN transmission and frequency channel change, for instance, the US2012/026997 proposes ‘A method and apparatus of accessing channel in a wireless communication system’. The method includes receiving, by a device, an operation element for setting up or switching at least one channel from an access point (AP), the operation element including a channel type field indicating whether the at least one channel is either a single channel or multiple channels, and the operation element including two channel center frequency segment fields indicating channel center frequency of a primary channel and a secondary channel respectively if the channel type field indicates that the at least one channel is multiple channels, determining whether the primary channel is idle during a first interval, determining whether the secondary channel is idle during a second interval if the primary channel is idle, and transmitting data by using the primary channel and the secondary channel to the AP or at least one station in a basic service set (BSS) if the primary channel and the secondary channel are idle.

U.S. Pat. No. 7,865,150 B2 proposes a ‘Dual Frequency Band wireless LAN’. A dual band radio is constructed using a primary and secondary transceiver. The primary transceiver is a complete radio that is operational in a stand-alone configuration. The second transceiver is a not complete radio and is configured to re-use components such as fine gain control, and frequency stepping of the primary transceiver to produce operational frequencies of the secondary transceiver. The primary transceiver acts like an intermediate frequency device for the secondary transceiver. Switches are utilized to divert signals to/from the primary transceiver from/to the secondary transceiver. The switches are also configured to act as gain control devices.

Another example is US 2011/255455 ‘Method and apparatus for Band switching in WLAN’. A method of switching band in a WLAN is provided. The method includes transmitting a multi-band switch request message to request switching from a first frequency band to a second frequency band, and receiving a multi-band switch response in response to the request. It includes a multi-band switch schedule to operate in the second frequency band. The US 2004/0037247 ‘Frequency hopping in 5 GHz WLAN via Dynamic Frequency Selection’ disclosed is a method and system for dynamically selecting a communication channel between an access point and a plurality of mobile terminals in a WLAN. The method having the steps of: measuring channel quality of a plurality of freq. channels and reporting to AP from MTs the channels including the RSSI and selecting one of those channels.

U.S. Pat. No. 7,864,744 ‘Method for dynamically selecting a channel in a wireless local area network’, disclosed is a method of dynamical frequency selection for a basic service set established by a main wireless device in a wireless local area network. The invention provides a dynamic frequency selection method without any modification of the IEEE 802.11 standard, or any requirement for the implementation of the wireless stations. In US 2010/0165923 ‘Wireless Network’, a wireless network is provided. The wireless network includes a predetermined wireless router and a plurality of wireless routers. The predetermined wireless router has gateway functionality for accessing an external network. Each wireless router of the wireless routers has a single transceiver, and the wireless routers include at least a wireless router which communicates with other wireless routers in the wireless network for forwarding network packets by using a single fixed channel and at least a wireless router which communicates with other wireless routers in the wireless network for forwarding network packets by using a plurality of channels. In this invention only one wireless network is created. In this invention different channels are used for communication, using the channel change as a possible improvement for data communication in a wireless mesh network (minimizing collisions and interference). But it does not explain the mechanism of how the channel change is made in the source and target router, it only mentions that there is a channel change. No mention of the creation of different networks with a single AP with a transceiver and using different frequency channels (using different channels only for trying to improve communication in a single mesh) is provided. It focuses on explaining methods for allocating communication channels for mesh networks and proposes an algorithm for this channel assignment. This is outside the scope of the present invention.

Other related patents for frequency channel switching and scanning are the U.S. Pat. No. 7,512,379: ‘Method for determining optimal AP for ACS and APA’ and Patent US 2011/0096739 ‘Smart Channel Scan on MIMO’.

### Problems with Existing Solutions

There are no systems that allow single transceiver multiband WLAN operation from a single AP, i.e., in current systems one WLAN AP transceiver and its associated STAs are all tuned to the same frequency channel at any given moment.

Multiple/Dual SSID: Current dual or multiple SSID implementations support dual or multiple VLANs in one same frequency channel. Interference in the channel leads to a cut or degradation in the WLAN transmission features. Dual or multiple SSID related operational procedures do not provide mechanisms for frequency channel change.

Device Manufacturers solutions: Regarding frequency channel change, existing solutions are based on vendor dependent mechanisms.

Under current vendor solutions, when change to a DFS channel is implemented WLAN communications are interrupted during one or ten minutes, depending on the channel, according to [3].

IEEE Standard: No references are found regarding WLAN multi-frequency operation in IEEE 802.11.

Finally, although there are some patents related to DFS scanning, frequency hopping and channel change methods in WLAN, as indicated before, there are no patents dealing with Access Points supporting two WLANs in a dual frequency mode, using a single half-duplex wireless transceiver.

For that reason, a new method for allowing an Access Point to support two WLAN communications in a dual frequency channel scheme, using a single half-duplex wireless transceiver and creating two independent WLANs, is presented in this invention.

The method provides a mechanism for avoiding interference and the possibility of making a smart frequency channel change without disturbing the WLAN transmissions. The method presented in the invention can be used for implementing a frequency channel change, dual WLANs transmissions and a prioritization process in WLAN communications.

### SUMMARY OF THE INVENTION

The object of the present invention is to provide a method and a system for allowing an Access Point (AP) to support/create two wireless networks, using said AP a single half-duplex wireless transceiver.

To that end, embodiments of the present invention relate, in a first aspect, to a method for creating two independent wireless networks with an access point, a first wireless network operating at a frequency channel A and a second wireless network operating at a frequency channel B. The method comprises:
at least one access point (AP) with a single half duplex radio transceiver changing a frequency channel between said frequency channel A and said frequency channel B in alternate periods of time
a plurality of associated stations operating in said frequency channel A
a plurality of associated stations operating in said frequency channel B

On the contrary to the known proposals, the method of the first aspect comprises, in a characteristic manner in order to create said two independent wireless networks from said one AP, updating a plurality of beacon parameters from a beacon frame at each change of channel frequency of said half duplex radio transceiver.

In the method of the present invention, each wireless network is assigned the same SSID or a different SSID, a different channel frequency (A or B) and different operation time intervals. So, one channel frequency is used to support the first wireless network during one time period and another channel frequency is used for the second wireless network during the complementary time period.

Then, the AP transmits and/or receives data packets to/from each one of the two wireless networks only during a corresponding operation time period. In case the AP does not receive the packets from one associated Station because the AP is not operating in that moment of time in the corresponding associated wireless network, the associated Station retries sending the data packets.

The method comprises a pre-configuring step of said plurality of beacon parameters of said beacon frame for the two wireless networks with a corresponding Basic Service Set Identifier (BBSID) parameter, one BBSID parameter corresponding to a first wireless network and another BBSID parameter corresponding to a second wireless network, and then transmitting, said at least one AP, data packets corresponding to said two wireless networks in two different queues, a first queue corresponding to the first wireless network and a second queue corresponding to the second wireless network.

The other parameters that are updated from said beacon frame are the SSID field parameters, the DS field parameters and HT info. The fields that are updated from the SSID field parameters are the SSID string field and the tag length field. The field that is updated from the DS field parameters is the channel number field and the fields that are updated from the HT info field are the Primary channel field and the HT info subset 1 field.

In another embodiment, a dynamic channel selection is performed by means of a channel scanning process in order to determine the channel frequency that better supports wireless operations avoiding interference and making a smart frequency channel change without disturbing the WLAN transmissions.

Finally, another embodiment comprises prioritizing the two wireless networks transmissions depending on a plurality of wireless services requirements. The prioritization can be performed by assigning different operation times and/or by assigning different channel frequencies to said two wireless networks, among other techniques.

A second aspect of the present invention, relates to a system for creating two independent wireless networks with an access point, a first wireless network operating at a frequency channel A and a second wireless network operating at a frequency channel B. The system comprises:
at least one access point (AP) with a single half duplex radio transceiver changing a frequency channel between said frequency channel A and said frequency channel B in alternate periods of time
a plurality of associated stations operating in said frequency channel A
a plurality of associated stations operating in said frequency channel B

On the contrary to the known proposals, the system of the second aspect comprises, in a characteristic manner in order to create said two independent wireless networks from said one AP, updating a plurality of beacon parameters from a beacon frame at each change of channel frequency of said half duplex radio transceiver.

The system of the second aspect is adapted to implement the method of the first aspect.

It is to be understood that the embodiments of the present invention and its description are intended to be illustrative and not restrictive. Many variations of the proposed invention will be apparent to those skilled in the art upon reviewing the above description. The goal of the present invention should be determined with reference to the appended claims, along with the full scope of equivalents to which such claims are entitled.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is a typical WLAN Switch Scheme.

FIG. 2 is a flowchart showing the method of the present invention, according to an embodiment.

FIG. 3 is a flowchart representing the time intervals definition followed by the method of the present invention, according to an embodiment.

FIG. 4 is an example of an IEEE 802.11 beacon frame consisting on a beacon frame header and a beacon frame body.

FIG. 5 is a representation of the beacon frame header showing the specific fields that are updated.

FIG. 6 is a representation of the modified beacon frame body fields, according to an embodiment.

FIGS. 7, 8 and 9 represent the different parameters fields that are modified or updated according to an embodiment.

FIG. 10 is a diagram illustrating a Dual channel communication embodiment for DFS implementation according to an embodiment.

FIG. 11 is a flowchart illustrating Dual channel communication embodiment for DFS implementation according to an embodiment.

FIG. 12 is a representation of a Dual channel communication prioritization scenario according to an embodiment.

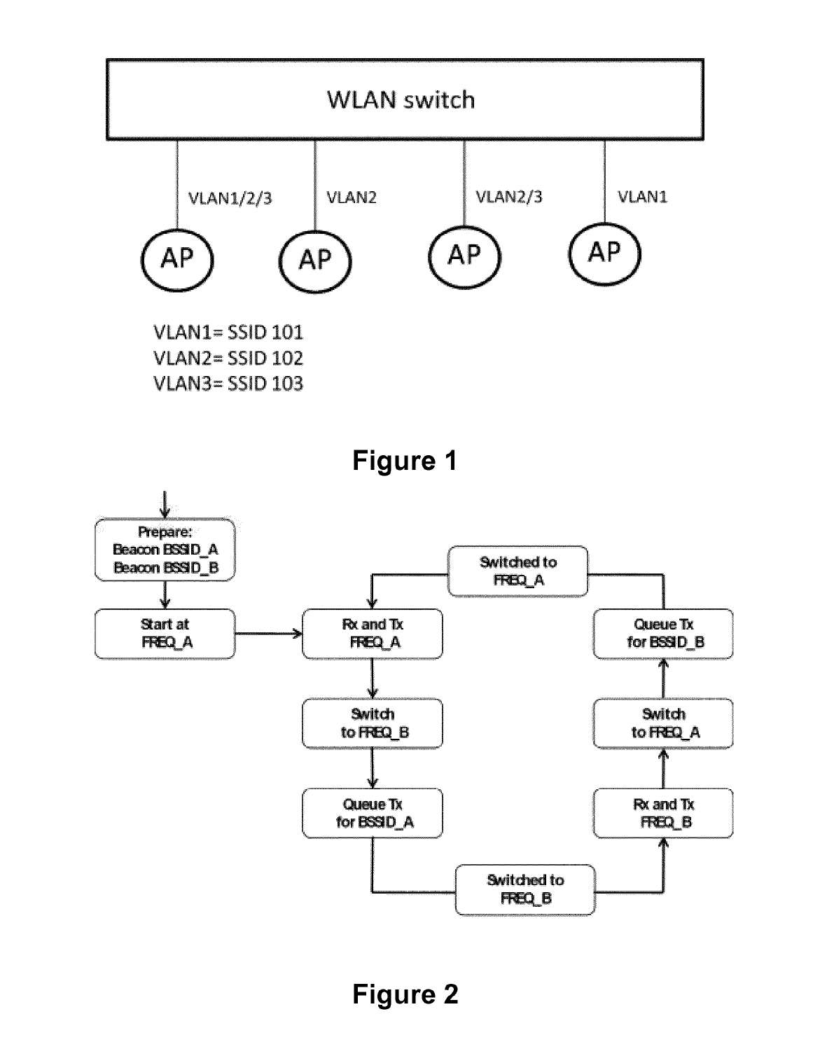

### DETAILED DESCRIPTION OF SEVERAL EMBODIMENTS

The present invention supports two different WLANs, with common or different SSIDs, from a single Access Point with a single RF transceiver, running in a frequency switching mode.

In the invention the term parameter is defined as the value of an IEEE 802.11 specification field that can be modified to implement the invention. In general, the parameters are wireless link specific, which in the invention is understood as client specific, since there is a link per client. The parameters used in the method may apply to a point to point or to a point to multipoint WLAN architecture, and are extensible to the case where STAs are used as relays.

The parameters relevant to the invention are listed in Table 1 with their description. The list refers to an individual link or client.

TABLE 1
Names and description of parameters used in the invention

| ParameterName | Type | Description |
|---|---|---|
| BSSID_A | Constant (6 octets) | MAC address for WLAN_A |
| | | (BSSID A) |
| BSSID_B | Constant (6 octets) | MAC address for WLAN_B |
| | | (BSSID B) |
| FREQ_A | Constant (Integers in | Frequency for WLAN_A |
| | units of MHz) | (BSSIDA) |
| FREQ_B | Constant (Integers in | Frequency for WLAN_B |
| | units of MHz) | (BSSID B) |
| SSID_A | Constant (String) | Name that identifies |
| | | WLAN_A |
| SSID_B | Constant (String) | Name that identifies |
| | | WLAN_ B |
| s_addr | Variable (6 octets) | Source MAC address |
| d_addr | Variable (6 octets) | Destination MAC address |
| op_time(A/B) | Constant (Integer in | WLAN (A/B) Time period |
| | units of msecs) | |
| stoptx_(A/B) | Constant (Integer in | Guard time preceding |
| | units of msecs) | channel frequency switch |

The BSSID (Basic Service Set Identifier) is the MAC (Media Access Control) address of the Wireless Access Point (Access Point, AP) to which an STA connects. It consists of 48 bits (6hexblocks),

Op_time(A/B): Time period, also termed operation time, during which packets are being transmitted or received in WLAN_A/B. Op_timeA is the operation time in WLAN_A and op_timeB is the operation time in WLAN_B.

Stoptx_(A/B): Defines the time period preceding a change in channel frequency during which packet transmission is interrupted. Stoptx_A is the time period preceding change from channel A to channel B, and Stoptx_B the one preceding change from channel B to channel A.

In an example embodiment, the method of the present invention works as follows:
1. As an initial optional step, the beacon frames for the two WLANs are preconfigured, with BSSID_A and BSSID_B respectively. The preconfiguration avoids later configuration during the switching channel time.
2. In the AP two queues are configured, for WLAN_A and WLAN_B packets, respectively. Packets to be transmitted in FREQ_A and FREQ_B are extracted from their respective queues.
3. WLAN_A (BSSID_A) starts receiving/transmitting packets in FREQ_A during op_timeA milliseconds.
4. During a guard time lasting stoptx_A no packets are transmitted.
5. When that period of time is finished, AP switches to FREQ_B and WLAN_B (BSSID_B) starts receiving/transmitting during op_timeB.
6. During a guard time lasting stoptx_B no packets are transmitted
7. The AP switches back to FREQ_A, and operation resumes with step 3.
8. Steps 3 to 7 alternate in a cyclic form.

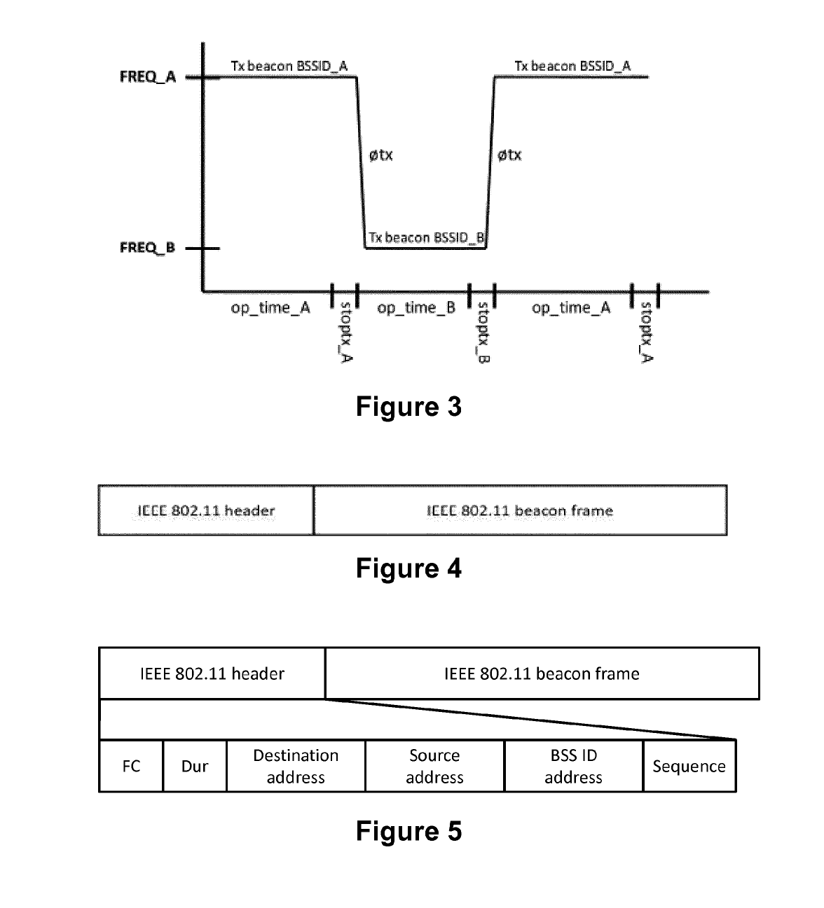

FIGS. 2 and 3 show example embodiments of the method of the present invention.

Beacon Switching description: In order to enable WLAN frequency switching with different BSSIDs, it is necessary to modify the beacon frame at each frequency hop. As depicted in FIG. 4, a beacon frame consists of an IEEE 802.11 header and a beacon frame body. Both octet sets are modified, with a set of values for WLAN_A and another for WLAN_B.

The specific fields that are updated in the IEEE 802.11 header are the following:
Source address: AP MAC address.
BSSID address: AP BSSID. Typically the same as source address, but not mandatory.
Sequence number: beacon sequence number.

The specific fields that are updated in the beacon frame are the following:
SSID parameters
DS parameters
HT info

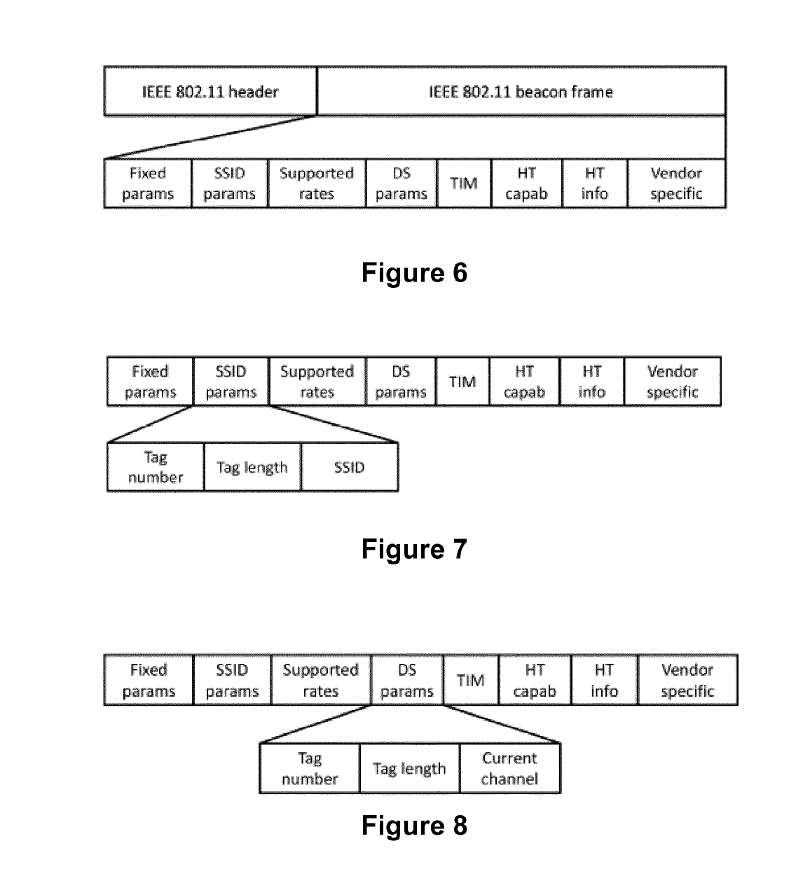

FIG. 6 shows in an embodiment the Beacon Frame body field modifications.

SSID parameters: The fields that are updated are the SSID string field and the tag length.

DS parameters: The only field that is modified is the DS parameter which contains the channel number used by the WLAN.

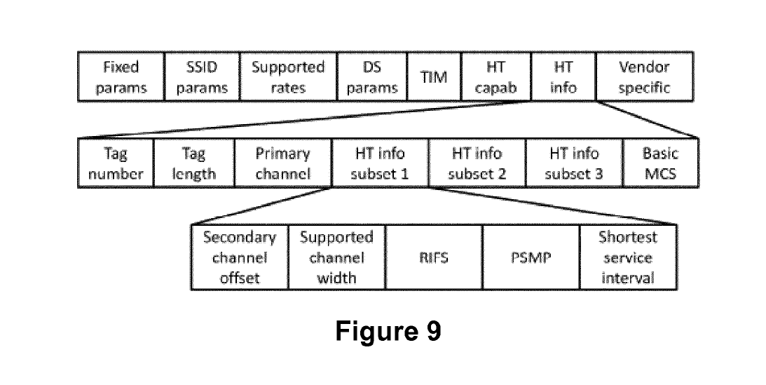

HT info: As indicated in FIG. 9, the fields that are modified in each frequency change are the Primary channel and the HT info subset 1.

The Primary channel is modified with the value of the current communication frequency channel (Freq_A or Freq_B).

The HT information subset 1 consists of five subfields. Only the subfield secondary channel offset must be modified with one of the following values:
+1: if the secondary frequency channel in the channel bonding is above the primary channel.
−1: if the secondary channel is below the primary channel.
0: otherwise (20 MHz BW communications, no channel bonding)

Without precluding any other wireless technology, the described method can be implemented in equipment conforming any of the following standards: IEEE802.11-2012, IEEE802.15.4 and IEEE802.16.

Yet other embodiments of the present invention define a method called ‘Dual WLAN channel’. The method may be used in several scenarios. Two of them are described below:
Dynamic Smart Frequency Channel selection and change scenario. The WLAN working in the enabled second channel is used for scanning WLAN available channels.
WLAN traffic data Prioritization scenario. Create and use a second communication channel for lower or higher priority data.

Dynamic Smart Frequency Channel Selection in 5 GHz WLAN DFS channels:

In this embodiment the invention is applied when a WLAN link performance is degraded due to interference coming from other WLAN devices (AP or STAs) working in the same frequency channel or in co-located frequency channels, as well as when channel change must be executed because a radar is detected in the current frequency channel. The interference problem is solved with a frequency channel change to a non-interfered channel.

In this embodiment a new method for performing a smart channel change in the 5 GHz Frequency Band with conformance to the IEEE 802.11 standard is defined. Some of the terms used are explained below:
Channel Availability Check: Scanning Process in the 5 GHz band, determining for each channel if there is a radar signal in the channel.
Available Channel: WLAN channel in the 5 GHz Band in which no radars signals have been detected during the time period defined in [3]. The set of available channels form the ‘available channel list’.
Unavailable Channel: 5 GHz band WLAN channel in which a radar signal is detected.
In-service monitoring: Process by which an AP monitors all Operating Channels to ensure that there is no radar operating in the channels
DFS: Dynamic Frequency Selection. Process for frequency channel change in the 5 GHz band specified in IEEE 802.11 conforming to ETSI regulations [3].

When different WLAN devices are sharing the same radio channels and are located physically close to each other, the WLAN desired throughput is reduced due to interferences; working in a new less interfered frequency channel will solve this problem. Additionally, when a radar signal is detected (using the DFS specified function ‘in-service monitoring’) in the current channel, a channel change must be performed. However, before the change is actually performed a check must be undertaken on whether in the proposed destination channel radar signals are present. The check process is as follows below.

According to ETSI [3], radar detection is required when RLANS are operating in channels whose nominal bandwidth falls partly or completely within the frequency ranges 5250 MHz to 5350 MHz (regulatory domain region UNII-2 Band) or 5470 MHz to 5725 MHz (region UNII-2 Extended). These channels are called DFS channels.

DFS defines the operational behaviour and individual requirements for co-existence associated to master (i.e. AP) and slaves (i.e. STA) RLAN devices in the 5 GHz band. As it is specified in [3] the initial Channel Availability Check may be activated manually at installation. A master device shall only start operations on Available Channels. At installation (or reinstallation) of these equipment, the RLAN is assumed to have no Available Channels within the band 5250 MHz to 5350 MHz and/or 5470 MHz to 5725 MHz (DFS channels). In such case, before starting operations on one or more of these channels, the master (AP) device shall perform either a Channel Availability Check (CAC) or an Off-Channel CAC to ensure that there are no radars operating on any selected channel. CAC minimum time is 10 minutes for channels belonging to 5600-5650 MHz Band and 1 minute for channels belonging to 5250-5350 MHz, 5470-5600 MHz and 5650-5725 MHz Bands.

If in a channel no radars are detected the channel will become an Available channel, which, when AP starts operating on that channel, becomes an Operating Channel. During normal operation, the master device shall monitor all Operating Channels (In-Service Monitoring) to ensure that there is no radar operating within these channel(s).

In all cases, if radar detection has occurred, the channel containing in which radar was detected becomes an Unavailable Channel. IEEE802.11 WLANs cannot use Unavailable channels.

The method proposed in the invention for implementing DFS, complying with ETSI rules without interrupting WLAN communication is:

If the DFS process is started when interference is detected in the operating channel, the effect of the interference cannot be removed with the intended frequency change till the change actually takes places, which change does not happen till the DFS process is finished, i.e., a minimum period of 1 or 10 minutes, depending on target change channel. In this invention a new procedure to implement DFS that overcomes this drawback is proposed. This procedure is a novel way to implement the In-service monitoring process.

The new procedure is as follows:
The dual channel method is activated WLAN_A is assigned to the operating channel
WLAN_B is reserved for scanning. During op_timeB, as defined in Section 3.1, a CAC and an off-channel CAC is performed in a channel. These checks are performed in different channels during different op_timeB periods
With the results of the CAC and off-channel CAC checks an available channel list is compiled and updated.

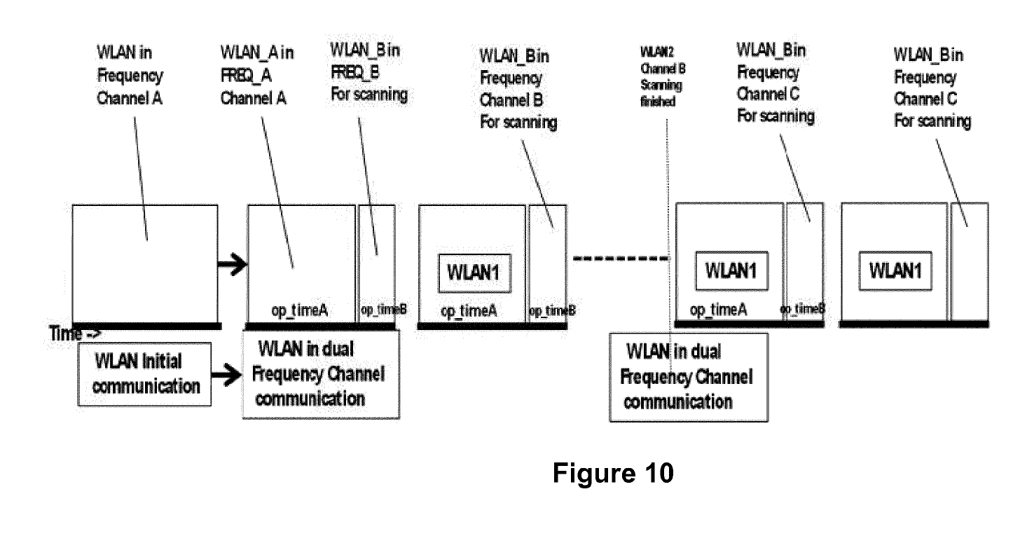

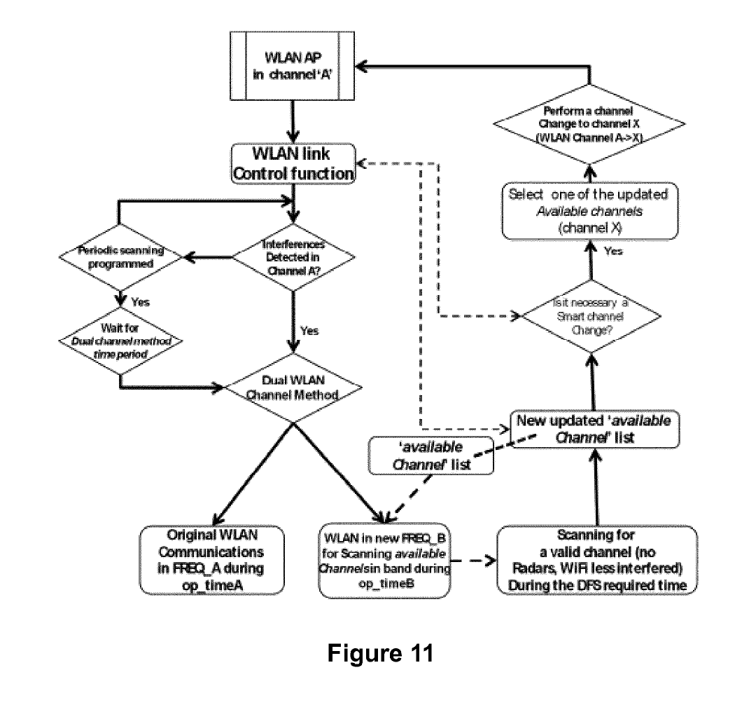

Since the available channel list is updated at all times, when a frequency change is required because of an unacceptable interference level the change can be performed immediately, to any channel in the available channel list. The procedure is depicted in FIG. 10 and FIG. 11.

According to ETSI regulations [3], pulse width in radars to be detected lies in the range 0.5 to 30 usec, with pulse repetition rate in the range 200 to 4000 pulses per second (PPS). Considering these radar features, if op_timeB is shorter or equal than the inactive pulse period it might not be possible to detect radars during that time. To prevent this, op_timeB must be higher than the pulse repetition period (in a worst case, with pps=200, op_timeB>5 ms).

The sum of all op_timeB periods for a given scanned frequency channel must be greater than 1 minute (or 10 minutes depending on the channel frequency) as defined by ETSI [3].

WLAN data communication prioritization scenario:

In this embodiment the dual WLAN channel method is used in order to provide from one AP two different WLANs, in two different channels with two different SSIDs, with differentiated priorities.

Priority differentiation can be achieved by two means: by assigning different operation times and/or by assigning different channel frequencies. The WLAN with higher priority is assigned the less interfered channel, while the other channel is assigned to the lower priority one. As an example, the channel with lower interference level can be assigned to HD video streaming and the other channel to low priority data traffic (i.e news web browsing).

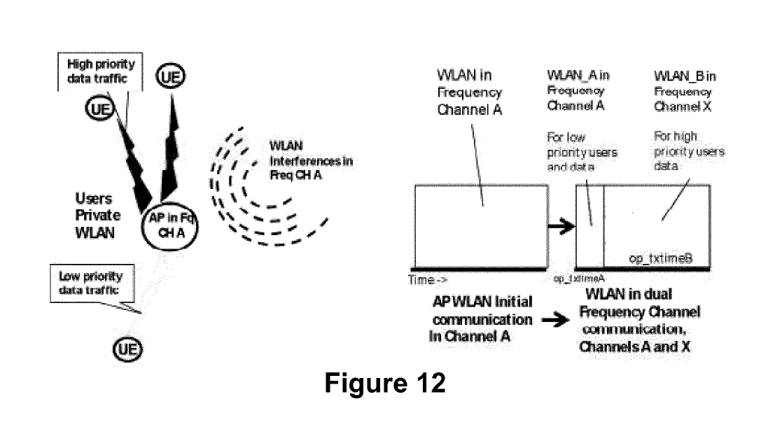

In addition to prioritizing by maintaining the high priority data traffic in the less interfered frequency channel, WLAN communications can also be prioritized by adjusting the transmissions times in each of the WLANs. With reference to FIG. 12, where priority is higher in WLAN_B, WLAN_A will have a short transmission operation time (op_timeA) while WLAN_B will have a longer transmission operation time (op_timeB), allowing higher throughputs in WLAN_B.

### Advantages of the Invention

The method provides several advantages in the field of Wi-Fi communications, as follows:
Two different WLANs, each on a different frequency channel, can be supported from the same AP with a single half-duplex radio transceiver.
A 5 GHz band frequency scan can be performed without interrupting a WLAN communication. This allows continuously maintaining an updated available channel list, which in turn allows frequency changes in the 5 GHz band to be performed immediately, without having to wait for an ETSI specified scanning time, since the scanning is always performed.
The previous advantage translates into extending the number of 5 GHz disjoints WLAN channels that can be used for TV continuous distribution from the current number of four to nineteen.
The method is manufacturer independent, because it works on parameters that are common to all IEEE802.11-2012 WLANs.
The method can be implemented not only on APs, but also in STAs, when they are operating as radio relays.

### ACRONYMS

### AP Access Point

### CSI Channel State Information

CSMA/CA Carrier Sense Multiple Access with Collision Avoidance

### DFS Dynamic Frequency Selection

### HDTV High Definition Television

### IP Internet Protocol

### LAN Local Area Network

### MAC Media Access Control

### MCS Modulation Coding Scheme

### MIMO Multiple Input Multiple Output

### MT Mobile Terminal

### QoS Quality of Service

### RLAN Radio Local Access Network

### RF Radio Frequency

### RSSI Received Signal Strength Indication

### SNR Signal-to-Noise Ratio

### SSI Signal Strength Indication

STA Station, also termed associated wireless client or simply client

### TCP Transmission Control Protocol

### UE User Equipment

### VLAN Virtual Local Area Network

### Wi-Fi Wireless Fidelity (IEEE 802.11)

### WLAN Wireless Local Area Network

### REFERENCES

[1] Wireless LAN Medium Access Control (MAC) and Physical Layer (PHY) Specifications IEEE 802.11-2012
[2] ‘IEEE 802.11h Technology and Application’ DajiQuiao, Sunghuyun Choi.
[3] ‘ETSI standard EN 301 893 V1.7.0’-2012
[4] ‘On-demand channel switching for multi-channel wireless MAC protocols’ PriyankPorwal and Maria Papadopouli Department of Computer Science University of North Carolina at Chapel Hill
[5] ‘Efficacy of Frequency Hopping in Coping with Jamming Attacks in 802.11 Networks’ Konstantinos Pelechrinis, Christos Koufogiannakis, and Srikanth V. Krishnamurthy, Member, IEEE′ IEEE communications 2010
[6] ‘Optimal WLAN Channel Selection Without Communication’ D. J. Leith, P. Clifford, D. Malone, D. Reid Hamilton Institute, National University of Ireland, Maynooth, Ireland
[7] ‘A Self-Managed Distributed Channel Selection Algorithm for WLANs’ D. J. Leith, P. Clifford Hamilton Institute, National University of Ireland, Maynooth, Ireland

1. A method for creating two independent wireless networks with an access point, a first wireless network operating at a frequency channel A and a second wireless network operating at a frequency channel B, comprising:
at least one access point (AP) with a single half duplex radio transceiver changing the frequency channel between said frequency channel A and said frequency channel B in alternate periods of time;
a plurality of associated stations operating in said frequency channel A; and
a plurality of associated stations operating in said frequency channel B,
characterized in that, in order to create said two independent wireless networks from said at least one AP, it comprises updating a plurality of beacon parameters from a beacon frame at each change of channel frequency of said single half duplex radio transceiver.

2. A method according to claim 1, characterized in that it further comprises:
pre-configuring said plurality of beacon parameters of said beacon frame for the two wireless networks with a corresponding Basic Service Set Identifier (BBSID) parameter, one BBSID parameter corresponding to said first wireless network and another BBSID parameter corresponding to said second wireless network, and
transmitting, from said at least one AP, data packets corresponding to said two wireless networks in two different queues, a first queue corresponding to said first wireless network and a second queue corresponding to said second wireless network.

3. A method according to claim 2, characterized in that it comprises transmitting and/or receiving said data packets from said at least one AP only during a corresponding operation time period.

4. A method according to claim 1, characterized in that said plurality of beacon parameters updating comprises modifying from said beacon frame the field parameters: SSID parameters, DS parameters and HT info.

5. A method according to claim 4, characterized in that it comprises updating from said SSID parameters a SSID string field and a tag length field.

6. A method according to claim 4, characterized in that it comprises updating from said DS parameters a channel number field.

7. A method according to claim 4, characterized in that it comprises updating from said HT info field a Primary channel field and a HT info subset 1 field.

8. A method according to claim 1, characterized in that it comprises assigning to each one of said two wireless networks a same or a different Service Set Identifier (SSID).

9. A method according to claim 8, characterized in that it comprises further assigning to each one of said two wireless networks a different frequency and different operation time intervals.

10. A method according to claim 1, characterized in that it performs a dynamic channel selection by means of a channel scanning process in order to determine said channel frequency that better supports wireless operations.

11. A method according to claim 1, characterized in that it comprises prioritizing said two wireless networks transmissions depending on a plurality of wireless services requirements.

12. A method according to claim 11, characterized in that it comprises performing said prioritizing said two wireless networks transmission by assigning different channel frequencies and/or assigning different operation time intervals to said two wireless networks.

13. A system for creating two independent wireless networks with an access point, a first wireless network adapted to operate at a frequency channel A and a second wireless network adapted to operate at a frequency channel B, comprising:
at least one Access Point (AP) with a single half duplex radio transceiver and adapted to change the frequency channel between said frequency channel A and said frequency channel B in alternate periods of time;
a plurality of associated stations adapted to operate in said frequency channel A; and
a plurality of associated stations adapted to operate in said frequency channel B,
characterized in that, in order to create said two independent wireless networks from said at least one AP, it comprises updating a plurality of beacon parameters from a beacon frame at each change of channel frequency of said single half duplex radio transceiver.

14. A system according to claim 13, characterized in that it is adapted to implement a method for creating the two independent wireless networks with an access point, the first wireless network operating at a frequency channel A and the second wireless network operating at a frequency channel B, comprising:
wherein, in order to create said two independent wireless networks from said at least one AP, the method comprises updating a plurality of beacon parameters from a beacon frame at each change of channel frequency of said single half duplex radio transceiver.
